(19) United States
(12) Patent Application Publication
(10) Pub. No.: US 2011/0221697 A1
(43) Pub. Date: Sep. 15, 2011

(54) LIQUID CRYSTAL DISPLAY DEVICE AND METHOD FOR MANUFACTURING THE LIQUID CRYSTAL DISPLAY DEVICE

(75) Inventors: Tetsuya Okamoto, Osaka (JP); Makoto Ohue, Osaka (JP); Manabu Abiru, Osaka (JP)

(73) Assignee: Sharp Kabushiki Kaisha, Osaka (JP)

(21) Appl. No.: 13/130,030

(22) PCT Filed: Jul. 21, 2009
(86) PCT No.: PCT/JP2009/003407

§ 371 Date: May 18, 2011

(30) Foreign Application Priority Data
Nov. 25, 2008 (JP) 2008-299758

(51) Int. Cl. G06F 3/041; H01J 9/26

(52) U.S. Cl. 345/173; 445/25

(57) ABSTRACT

A light shielding film includes a protrusion for a touch sensor, which is formed to protrude further than a color filter layer toward the side of a first substrate, and a spacer portion, which is formed to protrude further than the protrusion for a touch sensor toward the side of a first substrate and defines the thickness of a liquid crystal layer. A counter electrode, which covers the protrusion for a touch sensor and the color filter layer, is formed on a second substrate.

### TECHNICAL FIELD

The present invention relates to a liquid crystal display device which detects position information on the display screen and the method of manufacturing thereof.

### BACKGROUND ART

In recent years, liquid crystal display devices have been in widespread use in various apparatuses, including personal computers, mobile phones, PDA, game machines, and the like. Furthermore, also known are liquid crystal display devices which detect position information on the display screen through a touch panel formed to superimpose the liquid crystal display panel. Touch panel technologies which are known in general, for example, include the resistive technology and the optical imaging technology, and the like.

In the resistive technology, a transparent conductive film is affixed on the surface of a substrate that is affixed on a display panel and on the surface, on the side of the substrate, of a film that is affixed on the surface of this substrate across a small gap. Furthermore, a position where a finger or a pen is pressed is detected, as each of the aforementioned transparent conductive film comes into contact and a current flows.

Nevertheless, the reflected lights off of the surface of the display panel, off of the backside of the touch panel, from inside the touch panel, and off of the surface of the touch panel in a configuration, in which the touch panel is placed to overlay the display panel, create a problem of a reduced display contrast.

Also, as a result of each of the aforementioned reflected lights interfering with each other and creating a moiré, a problem arises of a reduced display quality. Furthermore, because of a structure in which the display panel and the touch panel are laminated, a problem arises of the overall display device becoming thick and heavy.

As such, liquid crystal display devices, which include the so-called in-cell touch panel, in which the liquid crystal display panel and the resistive touch panel form a single unit, have been proposed (see, for example, Patent Documents 1 through 3, and the like).

Disclosed in Patent Document 1 is a first touch electrode placed to overlap a gate wire and a source wire on a TFT substrate, which makes up a liquid crystal display panel, while a second touch electrode is placed to overlap a black matrix on a counter substrate, and as a result, the aforementioned first and second touch electrodes form a lattice.

Disclosed in Patent Document 2 is a spacer formed in a region, which is on a TFT substrate and facing opposite a color filter portion of a color, with which the cell thickness is minimum, while a protrusion for a touch sensor is formed with the same material as the spacer in a region, which is on the TFT substrate and facing opposite the other color filter portions, in a multi-gap type liquid crystal display device, in which each of the R, G, and B color filter portions having a different thickness, respectively, and formed on the counter substrate.

Disclosed in Patent Document 3 is a protrusion for a touch sensor, which is formed on a color filter layer, which is formed with each of the R, G, B color filter portions having the same thickness with each other, through a lamination of a plurality of colors of the same material as the color filter portion.

### RELATED ART DOCUMENTS

### Patent Documents

Patent Document 1: Japanese Patent Application Laid-Open Publication No. 2001-075074
Patent Document 2: Japanese Patent Application Laid-Open Publication No. 2007-052369
Patent Document 3: Japanese Patent Application Laid-Open Publication No. 2006-119446

### SUMMARY OF THE INVENTION

### Problems to be Solved by the Invention

Nevertheless, because it is necessary to form a sensor structure, such as a protrusion for a touch sensor, for detecting the touch position in the liquid crystal display devices of the aforementioned in-cell type touch panels, a problem arises of an increase in the number of manufacturing steps and a higher manufacturing cost.

For example, it is necessary to form the protrusion for a touch sensor and the spacer in a separate step from those for the color filter layer in Patent Documents 1 and 2, and the protrusion for a touch sensor must be formed in a separate step from the spacer in Patent Document 3. Therefore, the manufacturing cost can be reduced by a limited amount.

The present invention has been made in consideration of these issues with an object of reducing the number of manufacturing steps for a liquid crystal display device, in which the liquid crystal display panel and the resistive touch panel form a single unit, and to reduce the cost of manufacturing.

### Means of Solving the Problems

In order to achieve the aforementioned object, the liquid crystal display device of the present invention includes a first substrate on which a plurality of pixel electrodes are formed, a second substrate which is placed to face opposite the first substrate and on which are formed a color filter layer, which is made of color layers of a plurality of colors, and a light shielding film, which are formed at least between each of the color layers, and a liquid crystal layer formed between the first substrate and second substrate. The light shielding film includes a protrusion for a touch sensor, which is formed to protrude further than the color filter layers and toward the side of the first substrate, and a spacer portion, which is formed to protrude further than the protrusion for a touch sensor and toward the side of the first substrate and defines the thickness of the liquid crystal layer. A counter electrode, which covers the protrusion for a touch sensor and the color filter layers, is formed on the second substrate. A touch electrode, which is placed to face opposite a portion of the protrusion for a touch sensor through the counter electrode therebetween and comes into contact with and becomes conductive with the counter electrode when the second substrate is pressed down and bows toward the side of the first substrate, is formed on the first substrate.

A detection device, which is connected to the touch electrode and detects a conduction between the touch electrode and the counter electrode, may be placed on the first substrate.

A gate wire and a source wire, which extends and intersects with the gate wire, may be formed on the first substrate, and a detection wire, which extends along the gate wire, and the source wire may be connected to the detection device.

The protrusion for a touch sensor may include a first protrusion, which extends linearly between the color layers, which are adjacent to each other, and a second protrusion, which branches out of the first protrusion and extends to face opposite the touch electrode through the counter electrode therebetween.

Furthermore, a method of manufacturing the liquid crystal display device of the present invention is a method of manufacturing a liquid crystal display device, which includes a first substrate and a second substrate, which is placed opposite the first substrate through a liquid crystal layer therebetween and which includes color filter layers, which include colored layers of a plurality of colors, and a light shielding film, and in which a protrusion for a touch sensor, which is covered by a counter electrode, is formed on the second substrate, and, on the other hand, a touch electrode is formed on the first substrate and placed to face opposite the protrusion for a touch sensor through the counter electrode therebetween. The method of manufacturing the liquid crystal display device includes forming the first substrate, forming the second substrate, and affixing together the first substrate and the second substrate to each other and injecting and sealing a liquid crystal layer between the first substrate and the second substrate. A spacer portion, which defines the thickness of the liquid crystal layer, and the protrusion for a touch sensor are formed with the same material as the light shielding film as portions of the light shielding film in the step of forming the second substrate.

A detection device, which is connected to the touch electrode and detects conduction between the touch electrode and the counter electrode, may be formed on a substrate which makes up the first substrate in the step of forming the first substrate.

The spacer portion and the protrusion for a touch sensor may be formed by exposure through a half tone mask in the step of forming the second substrate.

A first protrusion, which extends linearly between the color layers, which are adjoining, and a second protrusion, which branches and extends off of the first protrusion and faces opposite the touch electrode through the counter electrode therebetween, may be formed as the protrusion for a touch sensor in the step of forming the second substrate.

### Effects of the Invention

The effects of the present invention will be described next.

The aforementioned liquid crystal display device displays a prescribed image, as a voltage is applied between a pixel electrode on a first substrate and a counter electrode on a second substrate, and a liquid crystal layer is driven.

On the other hand, when the second substrate is pressed down and bows toward the side of the first substrate, the counter electrode covering a protrusion for a touch sensor, which is formed on this second substrate, comes into contact and becomes conductive with the touch electrode on the first substrate. In this way, it is possible to detect the touch position on the second substrate based on the state of conduction between the counter electrode and the touch electrode.

In the present invention, the light shielding film, which is formed on the second substrate, includes the protrusion for a touch sensor and the spacer portion, and hence it is possible to simultaneously form the protrusion for the touch sensor and the spacer portion, which are portions of the light shielding film, in the same step of forming the light shielding film. Accordingly, it is possible to significantly reduce the number of manufacturing steps and greatly reduce its manufacturing cost.

Furthermore, when a detection device is formed on the first substrate, it is possible to detect the state of conduction between the touch electrode and the counter electrode using this detection device.

Furthermore, when a detection wire, extending along the gate wire, is formed on the first substrate, and the detection device is connected to this detection wire and the source wire, it is possible to detect the signal detected by the detection device through the detection wire or the source wire. In other words, it is possible to use the source wire not only for the image display, but also for the detection of the touch position.

Furthermore, when a first protrusion, which extends between the colored layers, and a second protrusion, which branches and extends off of this first protrusion, are formed on the protrusion for a touch sensor, it is possible to well detect the touch position on the second protrusion, while an increase in the area of the light shielding region in the display is suppressed.

### Effects of the Invention

According to the present invention, it is possible to simultaneously form the spacer portion and the protrusion for a touch sensor in the step of forming the light shielding film, because the spacer portion and the protrusion for a touch sensor are, respectively, formed as portions of the light shielding film. Hence, it is possible to reduce its number of manufacturing steps and significantly reduce the manufacturing cost.

### BRIEF DESCRIPTION OF THE DRAWINGS

FIG. 1 is a cross-sectional drawing schematically showing a vertical cross-sectional structure of a liquid crystal display device of the present embodiment.

FIG. 2 is a plan view drawing schematically showing a plurality of pixels in the liquid crystal display device of the present embodiment.

FIG. 3 is a magnified plan view drawing showing a single pixel on the TFT substrate.

FIG. 4 is a cross-sectional drawing along the line IV-IV of FIG. 3.

FIG. 5 is a circuit diagram showing the circuit structure including the TFT and a detection device.

FIG. 6 is a plan view drawing showing a light shielding film on the counter substrate, as seen from the side of the TFT substrate.

FIG. 7 is a cross-sectional drawing along the line VII-VII of FIG. 6.

FIG. 8 is a plan view drawing showing a mask for forming the light shielding film by half tone exposure of a resist layer.

FIG. 9 is a cross-sectional drawing showing a chrome layer and a resist layer, which are laminated on a glass substrate.

FIG. 10 is a cross-sectional drawing showing the resist layer, which is exposed through the mask.

FIG. 11 is a cross-sectional drawing showing a resist pattern, which is formed by development.

FIG. 12 is a cross-sectional drawing showing a portion of the chrome layer and the resist pattern during the etching step.

FIG. 13 is a cross-sectional drawing showing the light shielding film formed on the glass substrate.

FIG. 14 is a cross-sectional drawing showing a step of forming the colored layers.

### DETAILED DESCRIPTION OF EMBODIMENTS

The embodiments of the present invention are described in detail below based on drawings. Here, the present invention is not limited to the embodiments below.

### Embodiments of the Invention

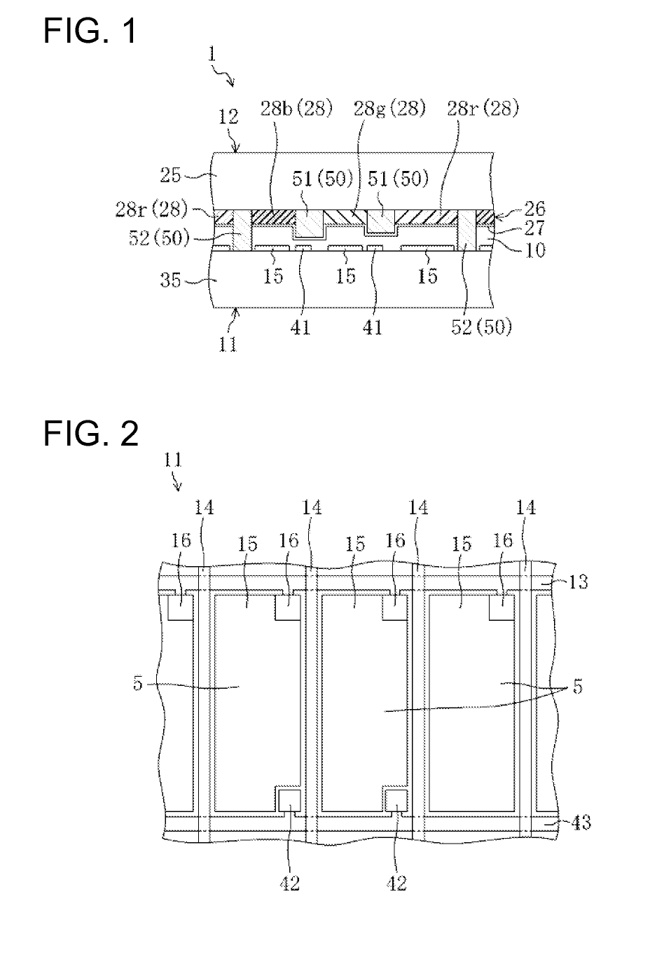

FIGS. 1-7 show the embodiments of the present invention.

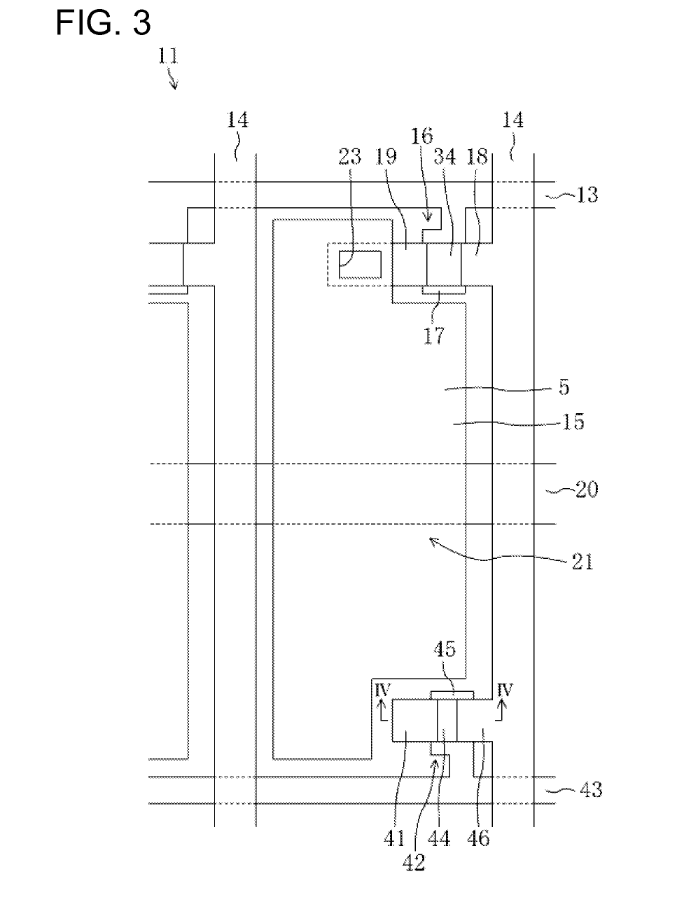

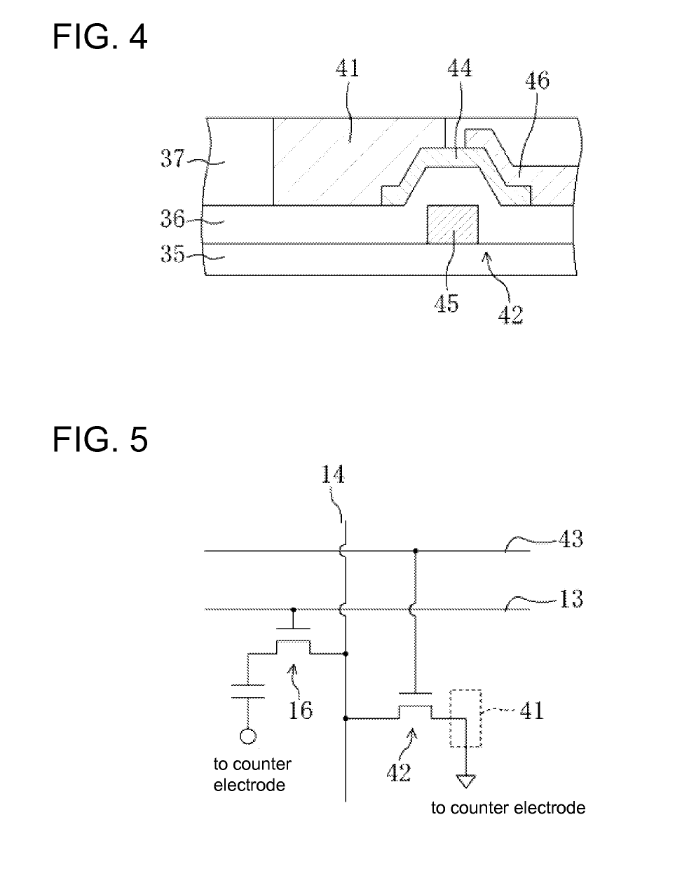

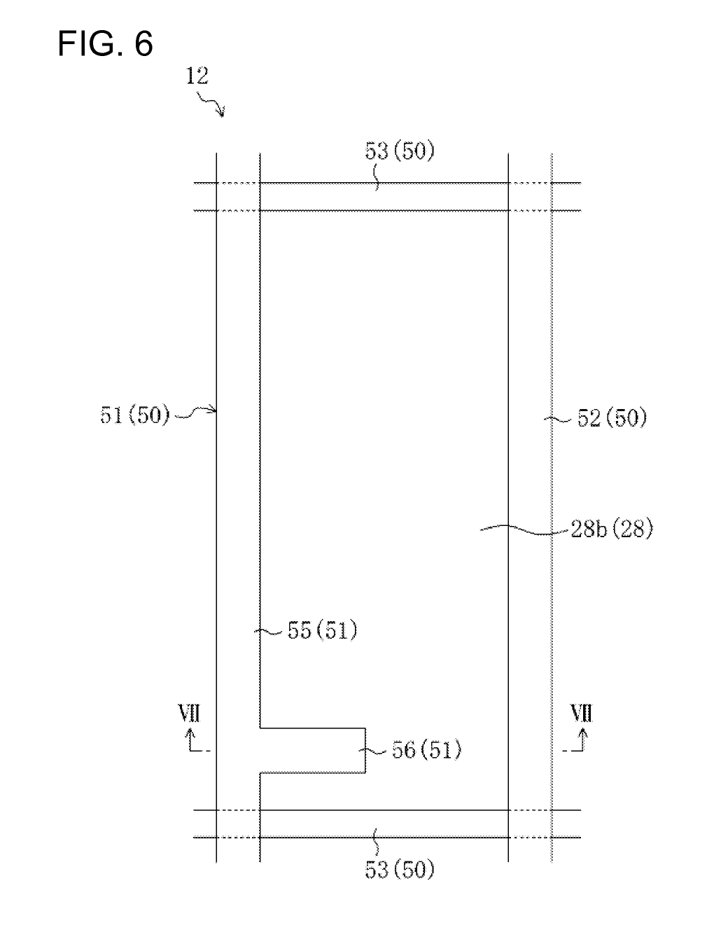

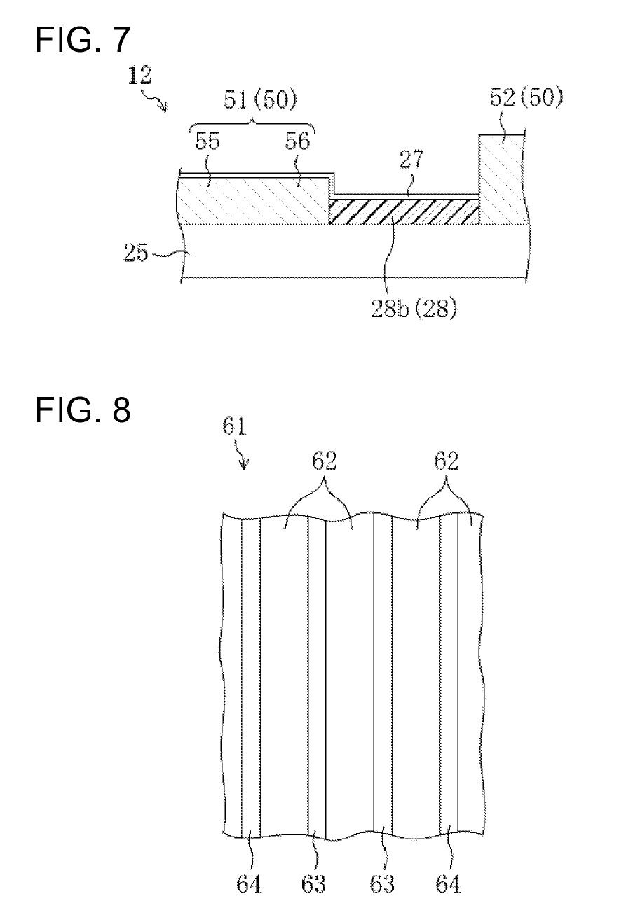

FIG. 1 is a cross-sectional drawing schematically showing a vertical cross-sectional structure of the liquid crystal display device 1 of the present embodiment. FIG. 2 is a plan view drawing schematically showing a plurality of pixels 5 of the liquid crystal display device 1 of the present embodiment. FIG. 3 is a magnified plan view drawing of one of the pixels 5 on the TFT substrate 11. FIG. 4 is a cross-sectional drawing along the line IV-IV of FIG. 3. FIG. 5 is a circuit drawing showing the circuit structure including the TFT 16 and detection device 42. Furthermore, FIG. 6 is a plan view drawing showing the light shielding film on the counter substrate as seen from the side of the TFT substrate. FIG. 7 is a cross-sectional drawing along the line VII-VII of FIG. 6.

The liquid crystal display device 1 of the present embodiment is a transmissive liquid crystal display device performing at least the transmissive display. The liquid crystal display device 1, as shown in FIG. 1, includes a TFT substrate 11, which is a first substrate, a counter substrate 12, which is a second substrate placed to face opposite the TFT substrate 11, and a liquid crystal layer 10 formed between the counter substrate 12 and the TFT substrate 11.

The liquid crystal display device 1, although not shown in the drawing, includes, for example, a rectangular shaped display region and a picture frame region, which is a non display region formed in the shape of a frame around this display region. The aforementioned display region includes a plurality of pixels 5 placed in to a matrix.

The counter substrate 12, as shown in FIG. 1, includes, for example, a glass substrate 25 of a thickness that is 0.7 mm or less, and a color filter layer 26 and a counter electrode (common electrode) 27, which are laminated in this order, on the side of the liquid crystal layer 10 on the glass substrate 25. The color filter layer 26 includes a plurality of colored layers 28. The colored layers 28 are made of a red color (R) colored layer 28r, a green colored (G) colored layer 28g, and a blue colored (B) colored layer 28b. The colored layers 28 of the respective colors are laid out in such a way that the three colors are placed in this order. Furthermore, the light shielding film 50 is formed at least between the respective colored layers 28.

The counter electrode 27 is formed of, for example, ITO (indium tin oxide) essentially uniformly across the entire display region in such a way as to cover a portion of the color filter layer 26 and the light shielding film 50. An orientation film, which is not shown in the figure, is formed on the surface of the counter electrode 27 on the side of the liquid crystal layer 10. Furthermore, a polarizer, which is not shown in the figure, is affixed on the glass substrate 25 on the surface on a side that is opposite from the liquid crystal layer 10.

On the other hand, the TFT substrate 11 is configured as a so-called active matrix substrate. The TFT substrate 11 includes, for example, a glass substrate 35, which has a thickness of 0.7 mm or less, and a plurality of gate wires 13 are formed in such a way as to extend in parallel with each other, as shown in FIG. 2 and FIG. 3. Furthermore, a plurality of source wires 14 are formed in such a way as to extend and intersect the aforementioned gate wires 13 on the TFT substrate 11. As a result, wires, which are made of the gate wires 13 and source wires 14, are formed in lattice shaped patterns on the TFT substrate 11.

Each pixel 5, as shown in FIG. 2 and FIG. 3, is formed with a rectangular shaped region defined by the aforementioned gate wires 13 and source wires 14. A plurality of pixel electrodes 15, which face opposite the counter electrodes 27, and a TFT (thin film transistor) 16, which is a switching device for switch-driving the liquid crystal layer 10 and is connected to the pixel electrodes 15, are formed in each pixel 5.

The TFT 16 is placed in the upper right corner portion, for example, of the pixel 5 in FIG. 2 and FIG. 3 and includes a gate electrode 17, which is connected to the gate wire 13, a source electrode 18, which is connected to the source wire 14, and a drain electrode 19, which is connected to the pixel electrode 15. In other words, the gate wire 13 and the source wire 14 are connected to the TFT 16. Furthermore, a semiconductor layer 34 is interposed between the gate electrode 17 and the source electrode 18 and the drain electrode 19.

The drain electrode 19 is covered by an interlayer insulating film (not shown in the figure), and a contact hole 23 is formed through this interlayer insulating film, as shown in FIG. 3. Furthermore, the drain electrode 19 is connected to the pixel electrode 15 through the contact hole 23. The pixel electrode 15 is covered by an alignment film, which is not shown in the figure.

In this way, signal voltages are supplied to the pixel electrode 15 from the source wire 14 through the source electrode 18 and the drain electrode 19, while the scanning voltage is applied on the gate electrode 17 through the gate wire 13. As a result, the liquid crystal layer 10 in this pixel 5 is driven by the signal voltage applied between the pixel electrode 15 and the counter electrode 27, and a prescribed image is displayed.

Furthermore, a plurality of capacitance wires 20 are formed in parallel with each other along the gate wires 13 in such a way as to pass through essentially the center of each pixel on the TFT substrate 11. An insulating film, which is not shown in the drawing, is interposed between the capacitance wire 20 and the pixel electrode 15, and a capacitor device 21, also called the supplemental capacitance, is formed by these. The capacitor device 21 is formed in each of the pixels 5, respectively, and maintains essentially a constant display voltage in each of the pixels 5.

Furthermore, as shown in FIGS. 1 to 4, a touch electrode 41 and a detection device 42, which is connected to the touch electrode 41, are respectively formed in each of the pixels 5 on the TFT substrate 11. The detection device 42 is for detecting a conductance between the touch electrode 41 and the counter electrode 27.

The detection device 42 is placed, for example, at the lower right corner portion of the pixel 5 in FIG. 2 and FIG. 3 and is formed of a TFT. The detection device 42 is connected to the detection wire 43, which extends along the aforementioned gate wire 13, and to the source wire 14, as shown in FIGS. 3-5.

In other words, the detection device 42 includes a gate portion 45, which is connected to the detection wire 43, a source portion 46, which is connected to the source wire 14, and a drain portion, which is the touch electrode 41. As shown in FIG. 4, the gate insulating film 36 is formed on the glass substrate 35 in such a way as to cover the gate portion 45. A semiconductor layer 44 is formed on the surface of the gate insulating film 36 in such a way as to cover the gate portion 45. Furthermore, the aforementioned source portion 46 and the touch electrode 41 are formed in such a way as to cover the surface of portions of the semiconductor layer 44. While the source portion 46 is covered by the interlayer insulating film 37, the touch electrode 41 is exposed and not covered by the interlayer insulating film 37.

As shown in FIG. 3, the touch electrode 41 is placed in a recessed portion of the pixel electrode 15 of each pixel 5, is formed in such a way that its surface is at the same height as those of the pixel electrode 15, and is placed in such a way as to face opposite the counter electrode 27. Furthermore, the touch electrode 41 is formed of, for example, ITO and is formed in the same step as the pixel electrode 15.

Furthermore, the light shielding film 50, which is formed on the counter substrate 12, includes a protrusion 51 for a touch sensor, a spacer portion 52, and a black matrix portion 53, as shown in FIG. 1, FIG. 6, and FIG. 7. In other words, the protrusion 51 for a touch sensor, the spacer portion 52, and the black matrix portion 53 are formed with the same material of, for example, a photosensitive resin, and each makes up the light shielding film 50.

The protrusion 51 for a touch sensor is formed in such a way as to protrude further than the color filter layer 26 toward the TFT substrate 11. The protrusion 51 for a touch sensor includes a first protrusion 55 and a second protrusion 56. The first protrusion 55 is formed in such a way as to extend linearly between the adjacent colored layers 28. On the other hand, the second protrusion 56 is formed in such a way as to branch off and protrude off from the first protrusion 55 and to face opposite the touch electrode 41 through the counter electrode 27 therebetween.

Furthermore, the first protrusion 55 is formed in such a way as to extend and overlap the source wire 14 on the TFT substrate 11, when viewed from the normal direction of the substrate. The second protrusion 56 extends in such a way as to cover the detection device 42 on the TFT substrate 11 and overlaps the touch electrode 41 at its tip portion, when viewed from the normal direction of the substrate.

The protrusion 51 for a touch sensor that is placed between the blue colored colored layer 28b and the green colored colored layer 28g, for example, as shown in FIG. 1, is slightly longer than the protrusion 51 for a touch sensor that is placed between the green colored colored layer 28g and the red colored colored layer 28r, and protrudes further toward the TFT substrate 11. Furthermore, the protrusion 51 for a touch sensor is covered by the counter electrode 27, along with the color filter layer 26.

On the other hand, the aforementioned spacer portion 52 is placed between, for example, the red colored colored layer 28r and the blue colored colored layer 28b. The spacer portion 52 is formed in such a way as to protrude further than the protrusion 51 for a touch sensor toward the TFT substrate 11, and is structured in such a way as to define the thickness of the liquid crystal layer 10, as its tip comes into contact with the TFT substrate 11. The spacer portion 52 is formed in such a way as to extend linearly and overlap the source wire 14 on the TFT substrate 11, when viewed from the normal direction of the substrate.

The black matrix portion 53 is formed in such a way as to extend and overlap the gate wire 13, when viewed from the normal direction of the substrate, and has a smaller thickness (that is, the height from the glass substrate 25) than the aforementioned protrusion 51 for a touch sensor. Here, the black matrix portion 53 may be formed in such a way as to extend and overlap at least one of the gate wire 13 and the detection wire 43, when viewed from the normal direction of the substrate.

On the other hand, the touch electrode 41, which is formed on the TFT substrate 11, is placed to face opposite a portion of the protrusion 51 for a touch sensor through the counter electrode 27 therebetween. In other words, the touch electrode 41 faces opposite the counter electrode 27 at the tip of the second protrusion 56 of the protrusion 51 for a touch sensor. In this way, the touch electrode 41 comes into contact and becomes conductive with the aforementioned counter electrode 27, when the counter substrate 12 is pressed down and bows toward the TFT substrate 11.

Touch Position Detection Method

Next, the method of detecting a touch position in the aforementioned liquid crystal display device 1 is explained.

When a prescribed scan voltage is applied on the detection wire 43 of a certain row, the touch electrode 41 and the source portion 46 of the detection device 42, which is connected to that detection wire 43 become conductive, and the detection device 42 is in the ON state. At this time, a current flows through the source wire 14 in accordance with the voltage applied on the counter electrode 27, if the counter substrate 12 is touched, and the counter electrode 27 at the tip of the protrusion 51 for a touch sensor (second protrusion 56) on the counter substrate 12 is in contact with the touch electrode 41 in the detection device 42, which is in the ON state as described above. The touch position is detected, as this current is detected.

On the other hand, if the counter substrate 12 is not touched, and the counter electrode 27 is not in contact with the touch electrode 41 in the detection device 42, which is in the ON state, then the current does not flow through the source wire 14. Accordingly, in this instance, the touch position is not detected, and no contact is detected. Accordingly, the touch position detection is conducted across the entire display region, as this series of position detection is conducted one after the other for each row.

Manufacturing Method

Next, a method of manufacturing the aforementioned liquid crystal display device 1 is explained with reference to FIGS. 8 to 14.

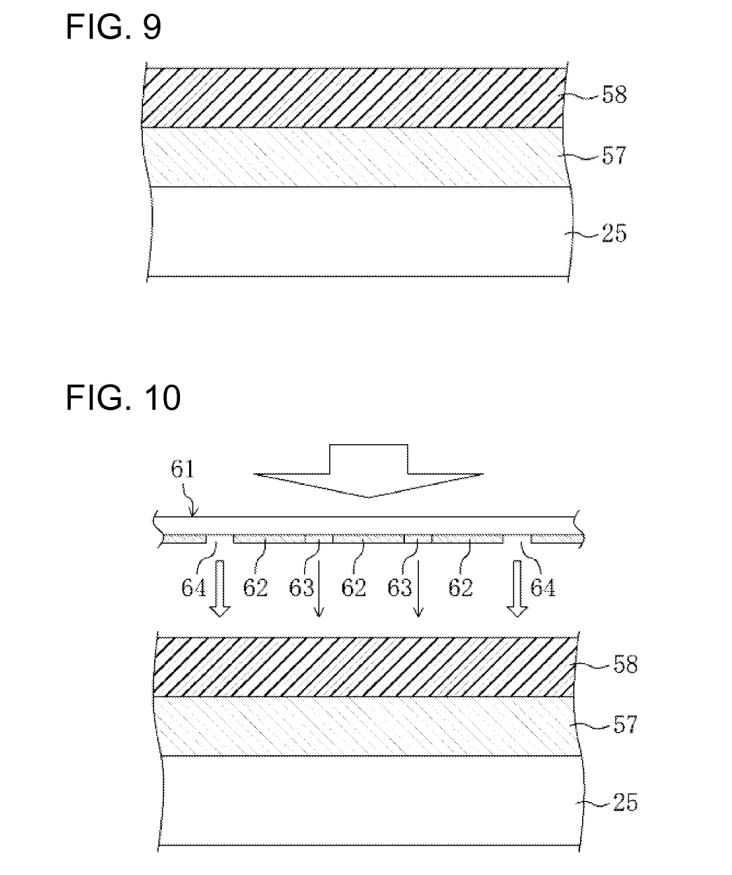

FIG. 8 is a plan view drawing showing a mask 61 for forming the light shielding film 50 by half tone exposure of a resist layer 58. FIG. 9 is a cross-sectional drawing showing a chrome layer 57 and the resist layer 58, which are laminated on the glass substrate 25. FIG. 10 is a cross-sectional drawing showing the resist layer 58, which has been exposed through the mask 61.

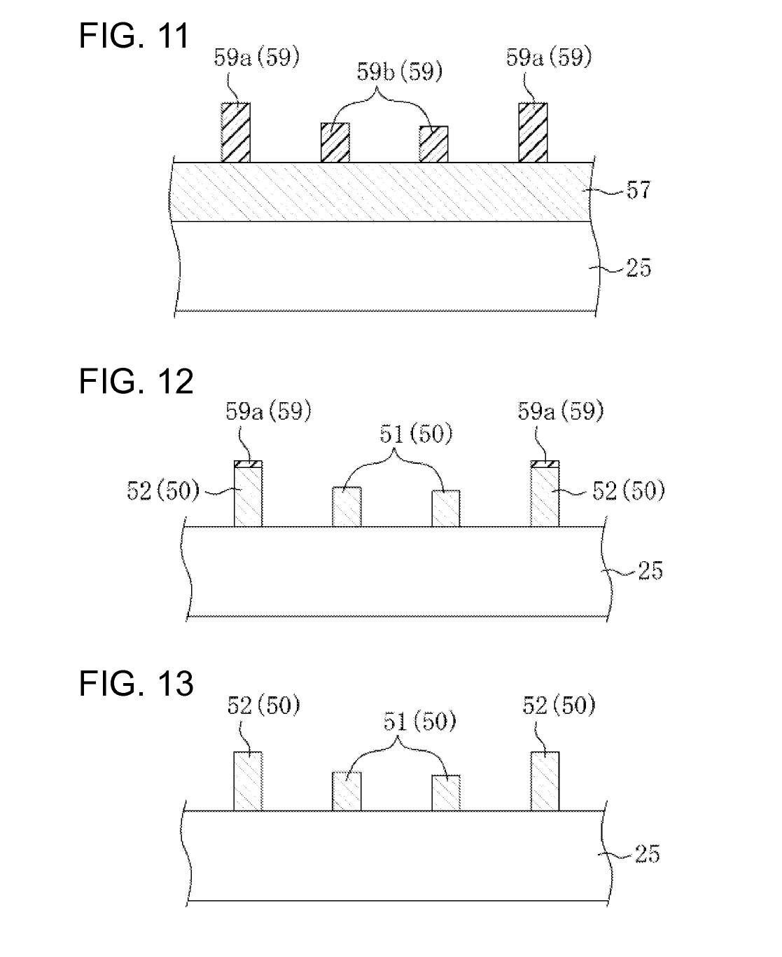

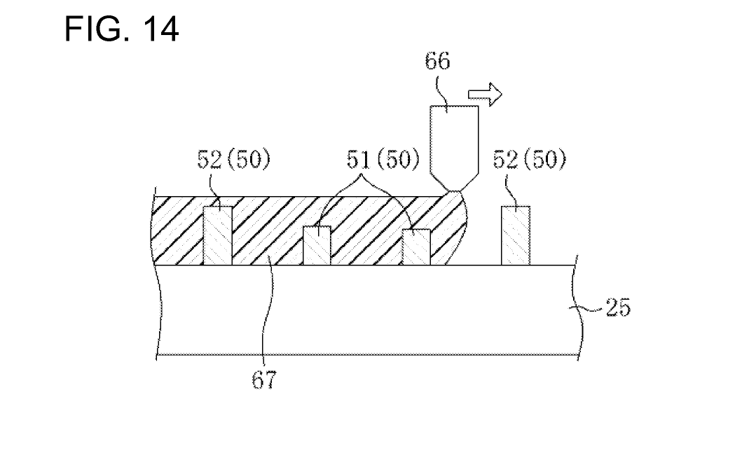

Furthermore, FIG. 11 is a cross-sectional drawing showing resist patterns 59, which are formed by development. FIG. 12 is a cross-sectional drawing showing a portion of the chrome layer 57 and the resist patterns 59 during the etching step. FIG. 13 is a cross-sectional drawing showing the light shielding film 50, which is formed on the glass substrate 25. FIG. 14 is a cross-sectional drawing showing a step of forming the colored layer.

First, a first step is conducted to form the TFT substrate 11. That is, the pixel electrode 15, TFT 16, and the detection device 42, and the like are formed by photolithography on the glass substrate 35, which makes up the TFT substrate 11. The detection device 42 is formed simultaneously in the same step as the TFT 16.

On the other hand, the counter substrate 12 is formed in a second step. Either the first step or the second step may be performed first. In the second step, after the color filter layer 26 and the light shielding film 50 are formed on the glass substrate 25, which makes up the counter substrate 12, an ITO film is deposited on the surface of this color filter layer 26 and the light shielding film 50 to form the counter electrode 27.

Here, in the second step, the spacer portion 52 and the protrusion 51 for a touch sensor are formed of the same material as the light shielding film 50 as portions of this light shielding film 50.

Specifically, after a brush cleaning for removing particles deposited on the glass substrate 25 is first conducted, the glass substrate 25 is dried using an air knife.

Next, the glass substrate 25 is loaded into a sputtering equipment, which is not shown in the figure, and a metal layer, which is to become the light shielding film 50 and is a chrome layer 57, for example, is deposited uniformly on the glass substrate 25, as shown in FIG. 9. Then, after an ultraviolet ray irradiation and brush cleaning of the glass substrate 25 are conducted in order to remove the particles depositing on the glass substrate 25, the glass substrate 25 is dried using an air knife or an oven, or the like. Next, a resist layer 58 of a negative photoresist material is formed uniformly on the surface of the chrome layer 57 by coating.

Next, as shown in FIG. 8 and FIG. 10, the resist layer 58 is half tone exposed through the mask 61. As a result of this, two types of resist patterns 59, which have different heights, are simultaneously formed on the chrome layer 57.

The mask 61 is a half tone mask, on which light shielding portions 62, which shield light (that is, the transmissivity is 0%), and semi-transmissive portions 63, which partially transmit light (for example, transmissivity is 50% or so), and opening portions 64 (that is, transmissivity is 100%) are formed. Then, UV light is irradiated on the resist layer 58 through the mask 61, and an exposure is conducted.

After that, development, post bake, and the like are conducted; first resist patterns 59a, which are relatively tall, are formed in the region opposing the opening portion 64; and at the same time, the second resist patterns 59b and the like, which are relatively short, are formed in the region facing opposite the semi-transmissive portion 63, as shown in FIG. 11.

Next, as shown in FIG. 12, etching is conducted on the chrome layer 57 and the resist pattern 59. In other words, an aqueous solution of ammonium cerium(IV) sulfate and perchloric acid is used for etching the chrome layer 57 and the resist patterns 59 at the same rate in order to form the two types of light shielding films 50, which have different heights. Because the relatively tall light shielding film 50 (spacer portion 52) is protected by the first resist patterns 59a through the end of etching, it is formed into a same height as the thickness of the chrome layer 57 before etching.

On the other hand, because the second resist patterns 59b for the relatively short light shielding film (protrusion 51 for a touch sensor) have a low height (smaller thickness), etching of the chrome layer 57 continues on after the second resist patterns 59b are completely etched during the etching step. As a result, the thickness of the chrome layer 57 becomes smaller, and the protrusions 51 for a touch sensor, which are the relatively short light shielding films 50, are formed.

After that, as shown in FIG. 13, the remaining first resist patterns 59a and the like are stripped and removed, and the glass substrate 25 is water cleaned and then dried. As a result of this, the light shielding film 50, which includes the protrusions 51 for a touch sensor and the spacer portions 52, is formed on the glass substrate 25.

Here, a representative example, in which the protrusion 51 for a touch sensor is formed using the semi-transmissive portion 63 of the mask 61, was explained. It is possible to simultaneously form the black matrix portion 53 through the formation of a plurality of semi-transmissive portions 63 that have different transmissivities on the mask 61 in the same manner as in the description above.

Next, as shown in FIG. 14, a resin layer 67, which is to become the colored layer 28, is coated using a slit coater 66 on the glass substrate 25, on which the aforementioned light shielding film 50 is formed. The slit coater 66 supplies the resin layer 67 on the glass substrate 25 as it moves in parallel with the surface of the glass substrate 25. The thickness of the resin layer 67 is controlled by adjusting the speed at which the slit coater 66 moves. Here, it is also possible to coat the resin layer 67 by spin coating or by an inkjet method.

For example, a resin layer 67, which is a resist in which a red colored pigment is dispersed, is first coated uniformly on the glass substrate 25. After that, and exposure, using a photo mask capable of irradiating light on regions in which the red colored colored layer 28r is to be formed, development, and a post bake are conducted to form the red colored colored layer 28r. Next, a resin layer 67, which is a resist in which green colored pigment is dispersed, is coated uniformly on the glass substrate 25. After that, an exposure, using a photo mask capable of irradiating light on regions in which the green colored colored layer 28g is to be formed, development, and a post bake are conducted to form the green colored colored layer 28g. Following that, the blue colored colored layer 28b is also formed similarly. Although the difference in step heights between the light shielding film 50 and the surface of the glass substrate 25 is 5 μm maximum in the formation of the colored layer 28, it is possible to coat the resin layer 67 uniformly.

After that, a step of forming the counter electrode 27 by sputtering of an ITO film takes place, and the aforementioned counter substrate 12 is manufactured. In this way, the protrusion 51 for a touch sensor, the spacer portion 52, and the black matrix portion 53 are formed simultaneously using the same material as the light shielding film 50 in this second step. Furthermore, the first protrusion 55, which extends linearly between the adjacent colored layers 28, and the second protrusion 56, which branches out and extends from this first protrusion 55 and faces opposite the touch electrode through the counter electrode 27 therebetween, are formed into the protrusion 51 for a touch sensor.

After that, a third step is conducted to affix together the TFT substrate 11 and the counter substrate 12 to each other and seal the liquid crystal layer 10 between the TFT substrate 11 and the counter substrate 12. The liquid crystal layer 10 is formed by a so-called drip injection method, with which the liquid crystal material is drip injected onto the TFT substrate 11 or the counter substrate 12. In this way, the aforementioned liquid crystal display device 1 is manufactured.

The Effects of the Embodiments

According to the present embodiments, the spacer portion 52 and the protrusion 51 for a touch sensor are formed as portions of the light shielding film 50, respectively, and hence it is possible to simultaneously form the spacer portion 52 and the protrusion 51 for a touch sensor in the step of forming the light shielding film 50. As a result, it is possible to reduce the number of process steps and significantly reduce the manufacturing cost.

In addition, according to the present embodiments, the spacer portion 52 and the protrusion 51 for a touch sensor, which are thicker than the colored layer 28, are formed between the colored layers 28 that are adjacent to each other, and hence, it is possible to suppress the mixing of colors among the colored layers 28.

Furthermore, the touch electrode 41, which comes into contact with the counter electrode 27, when the counter substrate 12 is pressed down, and the detection device 42, which detects the electrical conduction between the aforementioned touch electrode 41 and the counter electrode 27, are placed in a plurality of pixels 5, and hence, it is possible to construct a liquid crystal display device 1 that is thin overall, and to simultaneously detect multiple points of touch locations in spite of the resistive technology.

Furthermore, one of the detection wires connected to the detection device 42 is also used as the source wire 14, and hence it is possible to reduce the number of wires and improve the aperture ratio in the pixels 5.

In addition, the first protrusion 55, which extends between the colored layers 28, and the second protrusion 56, which branches and extends off from this first protrusion 55, are formed in the protrusion 51 for a touch sensor. Hence it is possible to detect the touch location on the second protrusion 56 in an improved manner, while an increase in the area of the light shielding region in the display is suppressed.

### Other Embodiments

In the aforementioned embodiments, an example was described, in which one of the two wires connected to the detection device 42 was common with the source wire 14, which is connected to the TFT 16 for display control. However, the present invention is not limited to this, and an additional configuration, in which one of the two wires connected to the aforementioned detection device 42 is made common with the gate wire 13, for example, is possible. Furthermore, it is also possible to form the two wires connected to the aforementioned detection device 42 separately and independently from the source wire 14 and the gate wires 13. In such an instance, two wires for detection, which extend along the source wire 14 and the gate wire 13, respectively, are formed. In this way, the detection of touch position becomes possible at all times and independently from the control of display through the gate wire 13 and the source wire 14, and hence, the detection accuracy can be further enhanced.

Furthermore, the TFT 16 and the detection device 42 are not limited to the TFT, and it is also possible to use other switching devices that turn on or off currents.

Furthermore, while the examples of liquid crystal display devices were described in each of the aforementioned embodiments, the present invention can also be applied similarly on other display devices, such as, for example, organic EL display devices.

### INDUSTRIAL APPLICABILITY

As thus described, the present invention is useful in a liquid crystal display device which detects position information on the display screen as well as its manufacturing method.

### DESCRIPTION OF REFERENCE CHARACTERS

1 liquid crystal display device
10 liquid crystal layer
11 TFT substrate (first substrate)
12 counter substrate (second substrate)
13 gate wire
14 source wire
15 pixel electrode
26 color filter layer
27 counter electrode
28 color layer
41 touch electrode
42 detection device
43 detection wire
50 light shielding film
51 protrusion for a touch sensor
52 spacer portion
53 black matrix portion
55 first protrusion
56 second protrusion
61 half tone mask

1. A liquid crystal display device comprising:
a first substrate on which a plurality of pixel electrodes are formed;
a second substrate which is placed to face opposite said first substrate and on which are formed a color filter layer, which is made of color layers of a plurality of colors, and a light shielding film, which are formed at least between each of said color layers; and
a liquid crystal layer formed between said first substrate and said second substrate,
wherein said light shielding film includes a protrusion for a touch sensor, which is formed to protrude further than said color filter layers toward said first substrate, and a spacer portion, which is formed to protrude further than said protrusion for a touch sensor toward said first substrate and which defines a thickness of said liquid crystal layer,
wherein a counter electrode, which covers the protrusion for a touch sensor and said color filter layers, is formed on said second substrate, and
wherein a touch electrode, which is placed to face opposite a portion of said protrusion for a touch sensor through said counter electrode therebetween and which comes into contact with and becomes conductive with said counter electrode when said second substrate is pressed down and bows toward said first substrate, is formed on said first substrate.

2. The liquid crystal display device according to claim 1, wherein a detection device, which is connected to said touch electrode and detects a conduction between said touch electrode and said counter electrode, is placed on said first substrate.

3. The liquid crystal display device according to claim 2, wherein a gate wire and a source wire, which extends and intersects with said gate wire, are formed on said first substrate, and a detection wire, which extends along said gate wire, and said source wire are connected to said detection device.

4. The liquid crystal display device according to claim 1, wherein said protrusion for a touch sensor includes a first protrusion, which extends linearly between said color layers that are adjacent to each other, and a second protrusion, which extends and branches out from said first protrusion and faces opposite said touch electrode through said counter electrode therebetween.

5. A method of manufacturing a liquid crystal display device, which includes a first substrate and a second substrate, which is placed opposite said first substrate through a liquid crystal layer therebetween and which includes a color filter layer that includes colored layers of a plurality of colors and a light shielding film, wherein a protrusion for a touch sensor, which is covered by a counter electrode, is formed on said second substrate, and wherein a touch electrode is formed on said first substrate and placed to face opposite said protrusion for a touch sensor through said counter electrode therebetween, the method comprising:
forming said first substrate;
forming said second substrate; and
affixing together said first substrate and second substrate to each other and injecting and sealing a liquid crystal layer between said first substrate and second substrate,
wherein a spacer portion, which defines a thickness of said liquid crystal layer, and said protrusion for a touch sensor are formed of a same material as said light shielding film as portions of said light shielding film in the step of forming said second substrate.

6. The method of manufacturing the liquid crystal display device according to claim 5, wherein a detection device, which is connected to said touch electrode and detects conduction between said touch electrode and said counter electrode, is formed on a substrate which makes up said first substrate in the step of forming said first substrate.

7. The method of manufacturing the liquid crystal display device according to claim 5, wherein said spacer portion and said protrusion for a touch sensor are formed by exposure through a half tone mask in the step of forming said second substrate.

8. The method of manufacturing the liquid crystal display device according to claim 5, wherein a first protrusion, which extends linearly between said color layers that are adjoining to each other, and a second protrusion, which branches and extends off from said first protrusion and faces opposite said touch electrode through said counter electrode therebetween, are formed as said protrusion for a touch sensor in the step of forming said second substrate.
